(19) United States
(12) Patent Application Publication
(10) Pub. No.: US 2013/0335662 A1
(43) Pub. Date: Dec. 19, 2013

(54) Hotspot Repair Method for LCD Panel and LCD Panel after Hotspot Repair

(71) Applicant: Tsunglung Chang, Shenzhen (CN)

(72) Inventor: Tsunglung Chang, Shenzhen (CN)

(21) Appl. No.: 13/575,343

(22) PCT Filed: Jun. 25, 2012
(86) PCT No.: PCT/CN2012/077409

§ 371 Date: Jul. 26, 2012

(30) Foreign Application Priority Data
Jun. 18, 2012 (CN) 201210201552.X

(51) Int. Cl. G02F 1/13

(52) U.S. Cl. CPC G02F 1/1309
USPC 349/43; 445/2

(57) ABSTRACT

The present disclosure provides a hotspot repair method for an LCD panel for increasing the quality of LCD panel, and an LCD panel after hotspot repair. The method includes the steps: A: Arranging repair line(s) on the short connected first TFT or second TFT to disconnect the data line from the first pixel electrode or the second pixel electrode; B: Bridging the first pixel electrode connected with the first TFT with the second pixel electrode connected with the second TFT. In the present disclosure, because the data line is disconnected from the pixel electrode by arranging the repair line on the short connected first TFT or second TFT, and the first pixel electrode connected with the first TFT is bridged with the second pixel electrode connected with the second TFT, hotspots are avoided, the pixel is not required to be repaired into dim spots, and the display quality of the LCD panel and the quality of the LCD panel are increased.

### TECHNICAL FIELD

The present disclosure relates to the field of liquid crystal displays (LCDs), and more particularly to a hotspot repair method for an LCD panel, and an LCD panel after hotspot repair.

### BACKGROUND

In the pixel design of an LCD device, a double thin film transistor (TFT) structure is designed to ensure sufficient charging for the pixel of Main&CC areas.

As shown in FIG. 1, a pixel structure comprises a first TFT 10, a second TFT 20, and a first pixel electrode 50 and a second pixel electrode 60 which are respectively connected with the first TFT 10 and the second TFT 20. However, the manufacturing process of TFT LCD panels includes process technology and transportation. A large number of particles are generated in the process, one part of the particles will be cleaned by a cleaning machine, and the other part of the particles will be remained on the LCD panel (, array substrate or color filter (CF) substrate). When the LCD panel is lightened, the particles remained on the TFT LCD panel may cause hotspots, bright (dark) lines, debris hotspots, weak bright (dark) lines, etc. which are not allowed to appear on the LCD panel. Therefore, an yttrium aluminum garnet (YAG) laser is used for repairing the LCD, to remove the particles or repair hotspots into dim spots.

To ensure the quality of the LCD panel and the sense of human eyes, hotspots are absolutely forbidden. Thus, hotspots should be repaired into dim spots. However, the number of dim spots is also required to a certain extent; too much dim spots can also reduce the grade of the LCD panel and even cause the discard of the LCD panel. Thus, the repair technique of the LCD panel is also critical in addition to reducing the particles of the machine and the environment as far as possible in the process of manufacturing LCD panels.

As shown in FIG. 2 and FIG. 3, when the first TFT or the second TFT of the pixel structure is short connected caused by the pollution of particles, hotspots are generated. Therefore, the hotspots are required to be repaired into dim spots. As shown in the Figure, the first TFT and the second TFT are respectively provided with first repair lines 11 and second repair lines 21, to respectively disconnect the polluted first TFT or second TFT from the first pixel electrode 50 and the second pixel electrode 60. Thus, when a scan line 40 is started, the first pixel electrode 50 and the second pixel electrode 60 cannot be charged. Therefore, the LCD cannot display and form dim spots.

### SUMMARY

In view of the above-described problems, the aim of the present disclosure is to provide a hotspot repair method for an LCD panel for increasing the quality of LCD panel, and an LCD panel after hotspot repair.

The aim of the present disclosure is achieved by the following technical scheme. A hotspot repair method for an LCD panel comprises the following steps:

A: Arranging repair line(s) on the short connected first TFT or second TFT to disconnect a data line from the first pixel electrode or the second pixel electrode; and

B: Drilling via holes in drain electrodes of the first TFT and the second TFT, bridging the drain electrode of the first pixel electrode connected with the first TFT with the drain electrode of the second pixel electrode connected with the second TFT by an Indium Tin Oxide (ITO), and respectively arranging both ends of the ITO in the via holes.

The aim of the present disclosure is further achieved by the following technical scheme. A hotspot repair method for an LCD panel comprises the following steps:

A: Arranging repair line(s) on the short connected first TFT or second TFT to disconnect a data line from the first pixel electrode or the second pixel electrode; and

B: Bridging the first pixel electrode connected with the first TFT with the second pixel electrode connected with the second TFT.

Preferably, in the step B, the first pixel electrode is bridged with the second pixel electrode by arranging an ITO between the drain electrodes of the first TFT and the second TFT. ITO is a transparent conducting material. Thus, the light transmittance of the LCD panel is not affected by using the ITO for bridging.

Preferably, in the step B, before arranging the ITO, the step further comprises: drilling via holes in the drain electrodes of the first TFT and the second TFT, and respectively arranging the two ends of the ITO in the via holes. By drilling the via holes and respectively arranging the two ends of the ITO in the via holes, the connecting reliability between the ITO and the pixel electrodes is increased.

Preferably, the via holes are drilled in the drain electrodes of the first TFT and the second TFT by a laser. Drilling the via holes by the laser has the advantages of simple technology and high accuracy.

Preferably, in the step A, the data line is disconnected from the first pixel electrode or the second pixel electrode by arranging repair line(s) between the drain electrode of the short connected first TFT and the first pixel electrode or between the drain electrode of the short connected second TFT and the second pixel electrode. The short connected TFT is disconnected from the pixel electrode by arranging repair line (s); thus, the data line is disconnected from the pixel electrodes without affecting other lines.

An LCD panel after hotspot repair comprises a pixel array. The pixel array comprises a plurality of pixel structures. Each pixel structure comprises a first TFT, a second TFT, and a first pixel electrode and a second pixel electrode which are respectively connected with the first TFT and the second TFT. The first TFT and the second TFT share one data line. In the pixel structure of forming hotspots, the short connected first TFT or second TFT is provided with repair line(s), the data line is disconnected from the first pixel electrode or the second pixel electrode by the repair line, and a bridge line is arranged between the first pixel electrode and the second pixel electrode.

Preferably, the bridge line is an ITO arranged between the drain electrodes of the first TFT and the second TFT. ITO is a transparent conducting material. Thus, the light transmittance of the LCD panel is not affected by using the ITO for bridging.

Preferably, the drain electrodes of the first TFT and the second TFT are provided with via holes, and the two ends of the ITO are respectively arranged in the via holes. By drilling the via holes and respectively arranging the two ends of the ITO in the via holes, the connecting reliability between the ITO and the TFTs is increased.

Preferably, the via holes in the drain electrodes of the first TFT and the second TFT are drilled by a laser. Drilling the via holes by the laser has the advantages of simple technology and high accuracy.

Preferably, the repair line(s) is arranged between the short connected first TFT and the first pixel electrode or between the short connected second TFT and the second pixel electrode. The short connected TFT is disconnected from the pixel electrode by arranging the repair line(s); thus, the data line is disconnected from the pixel electrode without affecting other lines.

In the present disclosure, because the data line is disconnected from the pixel electrode by arranging the repair line(s) on the short connected first TFT or second TFT, and the first pixel electrode connected with the first TFT is bridged with the second pixel electrode connected with the second TFT, if the first TFT is not short connected and the second TFT is short connected because of being polluted by particles, when the first TFT is switched on, the disconnected second TFT cannot charge the second pixel electrode, but the first TFT can charge both the first pixel electrode and the second pixel electrode. Thus, corresponding gray scale(s) is displayed by the pixel, hotspots are avoided, the pixel is not required to be repaired into dim spots, and the display quality of the LCD panel and the quality of the LCD panel are increased; correspondingly, if the first TFT is short connected but the second TFT is not short connected, the condition is the same.

### BRIEF DESCRIPTION OF FIGURES

FIG. 1 is a simplified structure diagram of a pixel structure of an LCD panel;

FIG. 2 is a schematic diagram of an LCD panel of which hotspots are repaired into dim spots;

FIG. 3 is a schematic diagram of an LCD panel of which hotspots are repaired into dim spots;

FIG. 4 is a simplified structure diagram of a pixel structure of an LCD panel of an example of the present disclosure; and

FIG. 5 is a flow diagram of a hotspot repair method of the present disclosure.

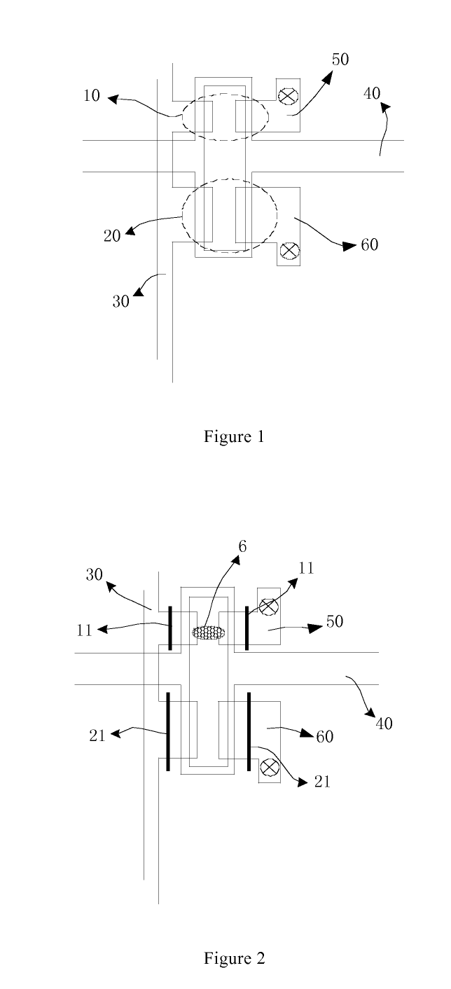

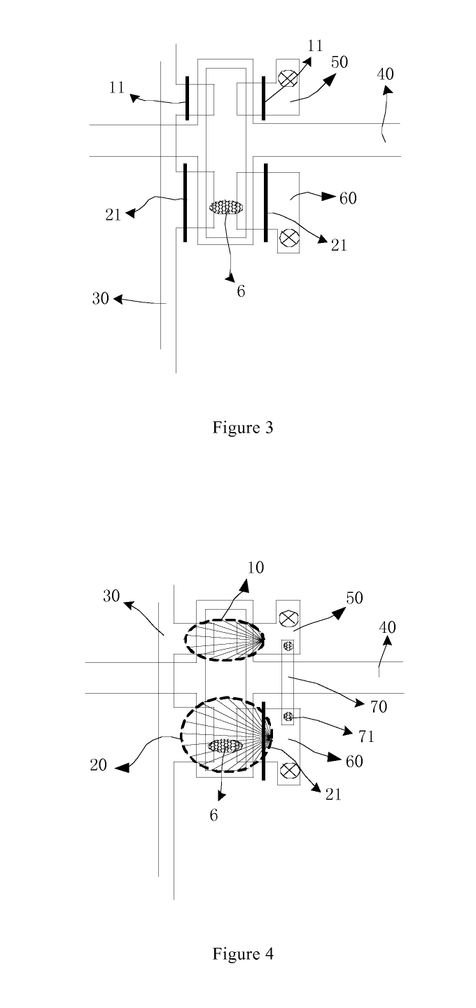

Legends: 6. particle; 10. first TFT; 11. first repair line; 20. second TFT; 21. second repair line; 30. data line; 40. scan line; 50. drain electrode (first TFT); 60. drain electrode (second TFT); 70. ITO; 71. via hole.

### DETAILED DESCRIPTION

The present disclosure will be further described in accordance with the Figures and preferred examples.

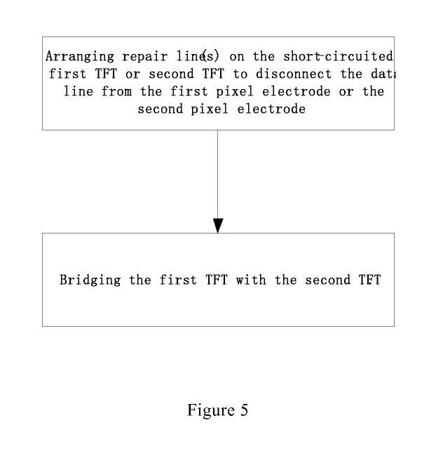

As shown in FIG. 5, the present disclosure provides a hotspot repair method for an LCD panel, comprising:

A: Arranging repair line(s) on the short connected first TFT or second TFT to disconnect the data line from the first pixel electrode or the second pixel electrode; and

B: Bridging the first pixel electrode connected with the first TFT with the second pixel electrode connected with the second TFT.

The LCD panel comprises an array substrate and a CF substrate; the array substrate is provided with a plurality of pixel structures. As shown in FIG. 4, an LCD panel having hotspots is repaired in accordance with the hotspot repair method provided by the present disclosure. As shown in the Figure, the structure after the pixel structure with hotspots is repaired comprises a first TFT 10, a second TFT 20, and a first pixel electrode and a second pixel electrode (not shown in the Figure) which are respectively connected with the first TFT 10 and the second TFT 20. The first TFT 10 and the second TFT 20 share one data line 30 and one scan line 40. Because particles 6 are remained on the second TFT 20 in the process of manufacturing the LCD panel, the second TFT 20 is short connected. To avoid generating hotspots, the short connected second TFT 20 is required to be provided with second repair line(s) 21 to disconnect the data line 30 from the second pixel electrode, thereby avoiding generating hotspots. An ITO 70 is arranged between the first TFT 10 and the second TFT 20 to bridge the first TFT 10 with the second TFT 20. Specifically, the ITO 70 is arranged between the drain electrode 50 of the first TFT 10 and the drain electrode 60 of the second TFT 20. Because the drain electrode 50 of the first TFT 10 is connected with the first pixel electrode, and the drain electrode 60 of the second TFT 20 is connected with the second pixel electrode, the bridging between the drain electrode 50 of the first TFT 10 and the drain electrode 60 of the second TFT 20 is equivalent to the bridging between the first pixel electrode and the second pixel electrode. When the first TFT 10 is switched on, the first pixel electrode obtains a charging voltage V1, and the second pixel electrode also obtains a charging voltage V1 because the first TFT 10 is bridged with the second TFT 20 by the ITO 70; thus, the LCD panel displays the gray scale corresponding to the voltage V1 in the position of the pixel at this moment.

The drain electrode 50 of the first TFT 10 and the drain electrode 60 of the second TFT 20 are respectively drilled with via holes 71 by a laser, the two ends of the ITO 70 are respectively arranged in the via holes 71, and then the connecting reliability between the ITO 70 and the two TFTs is increased. As the bridge line between the first TFT 10 and the second TFT 20, because the ITO 70 has transmission of light, the light transmittance of the LCD panel is not affected. Optionally, other conducting material can also be selected as the bridge line between the first TFT 10 and the second TFT 20.

The specific repair method of the pixel structure after repair in the example comprises the following steps:

A: Arranging the second repair line(s) 21 on the short connected second TFT 20 to disconnect the data line 30 from the second pixel electrode, and specifically, the second repair line 21 is arranged between the drain electrode 60 of the second TFT 20 and the second pixel electrode; optionally, the repair line can be arranged between the data line 30 and the second TFT 20; and

B: Bridging the first pixel electrode connected with the first TFT 10 with the second pixel electrode connected with the second TFT 20.
Specifically, the step B further comprises:

Step B1: Drilling via holes 71 in the drain electrode 50 of the first TFT 10 and the drain electrode 60 of the second TFT 20.

In the step B, the first pixel electrode connected with the first TFT 10 is bridged with the second pixel electrode connected with the second TFT 20 by arranging an ITO 70 between the drain electrode 50 of the first TFT 10 and the drain electrode 60 of the second TFT 20. The ITO 70 is a transparent conducting material. Thus, the light transmittance of the LCD panel is not affected by using the ITO 70 for bridging; meanwhile, the two ends of the ITO 70 are respectively arranged in the via holes 71, and the ITO 70 is more reliably connected with the TFTs (the drain electrode 50 of the TFT 10 and the drain electrode 60 of the second TFT 20) by the via holes 71.

In the example of the present disclosure, because the particles 6 are remained on the second TFT 20, the second TFT 20 needs to be disconnected from the second pixel electrode, thereby avoiding generating hotspots; optionally, when the particles 6 are remained on the first TFT 10, the first TFT 10 is required to be provided with repair line(s) to disconnect the first TFT from the first pixel electrode; correspondingly, the first TFT 10 is required to be bridged with the second TFT 20, to charge both the first pixel electrode and the second pixel electrode, thereby avoiding generating dim spots.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A hotspot repair method for a liquid crystal display (LCD) panel, comprising: the following steps:
A: Arranging repair line(s) on a short collected first thin film transistor (TFT) or second thin film transistor (TFT) to disconnect a data line from a first pixel electrode or a second pixel electrode;
B: Drilling via holes in drain electrodes of the first thin film transistor (TFT) and the second thin film transistor (TFT), bridging the drain electrode of the first pixel electrode connected with the first thin film transistor (TFT) with the drain electrode of the second pixel electrode connected with the second thin film transistor (TFT) by an Indium Tin Oxide (ITO), and respectively arranging both ends of the Indium Tin Oxide (ITO) in the via holes.

2. A hotspot repair method for a liquid crystal display (LCD) panel, comprising: the following steps:
A: Arranging a repair line(s) on a short-circuited first thin film transistor (TFT) or second thin film transistor (TFT) to disconnect a data line from a first pixel electrode or a second pixel electrode;
B: Bridging the first pixel electrode connected with the first thin film transistor (TFT) with the second pixel electrode connected with the second thin film transistor (TFT).

3. The hotspot repair method for an LCD panel of claim 2, wherein in the step B, the first pixel electrode is bridged with the second pixel electrode by arranging an ITO between the drain electrodes of the first TFT and the second TFT.

4. The hotspot repair method for an LCD panel of claim 3, wherein in the step B, before arranging the ITO, the step further comprises: drilling via holes in the drain electrodes of the first TFT and the second TFT, and respectively arranging both ends of the ITO in the via holes.

5. The hotspot repair method for an LCD panel of claim 4, the via holes are drilled in the drain electrodes of the first TFT and the second TFT by a laser.

6. The hotspot repair method for an LCD panel of claim 2, wherein in the step A, the data line is disconnected with the first pixel electrode or the second pixel electrode by arranging repair line(s) between the short connected first TFT and the first pixel electrode or between the short connected second TFT and the second pixel electrode.

7. A liquid crystal display (LCD) panel after hotspot repair, comprising:
an array substrate comprising a plurality of pixel structures;
wherein each the pixel structure comprises a first TFT, a second TFT, and a first pixel electrode and a second pixel electrode which are respectively connected with the first TFT and the second TFT;
wherein in the pixel structure of forming hotspots, the short connected first TFT or second TFT is provided with repair line(s), the data line is disconnected from the first pixel electrode or the second pixel electrode by the repair line, and a bridge line is arranged between the first pixel electrode and the second pixel electrode.

8. The LCD panel after hotspot repair of claim 7, wherein the bridge line is an ITO arranged between the drain electrodes of the first TFT and the second TFT.

9. The LCD panel after hotspot repair of claim 8, wherein the drain electrodes of the first TFT and the second TFT are provided with via holes, and the two ends of the ITO are respectively arranged in the via holes.

10. The LCD panel after hotspot repair of claim 9, wherein the via holes in the drain electrodes of the first TFT and the second TFT are drilled by a laser.

11. The LCD panel after hotspot repair of claim 9, wherein the repair line(s) is arranged between the short connected first TFT and the first pixel electrode or between the short connected second TFT and the second pixel electrode.
